(19) United States
(12) Patent Application Publication
(10) Pub. No.: US 2006/0068065 A1
(43) Pub. Date: Mar. 30, 2006

(54) Container comprising edible manifold

(75) Inventors: David C. Rettey, Tracy, MN (US); Krishna K. Kanuru, Marshall, MN (US); Wayne M. Pafko, Marshall, MN (US); Mark E. Ingelin, Marshall, MN (US); Mohamed M. Morad, Marshall, MN (US)

Correspondence Address: Attn: Julie R. Daulton;MERCHANT & GOULD P.C., P.O. Box 2903, Minneapolis, MN, 55402-0903, US

(73) Assignee: Schwans Sales Enterprises, Inc., Marshall, MN (US)

(21) Appl. No.: 11/282,369

(22) Filed: Nov. 18, 2005

Related U.S. Application Data
(62) Division of application No. 10/177,731, filed on Jun. 20, 2002.
(60) Provisional application No. 60/301,645, filed on Jun. 28, 2001.

(51) Int. Cl. A21D 13/00

(52) U.S. Cl. 426/138

(57) ABSTRACT

A bread bowl or boule comprises a spherical edible shell. The volume of the shell provides a space, volume, or container of at least one individual serving size portion of a food material. The bowl typically comprises a spherical shell with an opening resulting from a section removed. The bowl can be manufactured by forming a bakable shell surrounding a fugitive space filling composition. Upon baking, the heat of baking results in a change of state such that the fugitive space filling material exits the interior of the bowl leaving a volume suitable for a single serving portion. The structure adapted for baking comprises an exterior dough shell and an interior fugitive section. Extruding the dough with a fugitive composition in the interior and sealing the extruded ends into a substantially rounded or spherical structure can make the production unit. In preparation, the unbaked bowl is baked leaving a spherical hollow structure. A section of the sphere is removed, exposing the interior volume and the consumable food is then introduced into the interior of the bowl.

### RELATED APPLICATIONS

This application is a divisional application of pending U.S. application Ser. No. 10/177,731, filed Jun. 20, 2002. Application Ser. No. 10/177,731 claims the benefit of provisional patent application Ser. No. 60/301,645, filed on Jun. 28, 2001. Application Ser. Nos. 10/177,731 and 60/301,645 are incorporated by reference herein.

### FIELD OF THE INVENTION

The invention relates to a consumable baked or parbaked manifold that can be formed into a enclosed edible form or shape surrounding a void space. The container can be opened and filled with a food. The shape or volume can be adapted for containing at least an appetizer, a single or individual serving-sized portion or two or more such portions of a food. Such foods can include breakfast, lunch, dinner, brunch, snacks, soups, stews, salads, chili, chicken salad, ham salad, poached eggs, scrambled eggs, desserts, fruit fillings, etc.

### BACKGROUND OF THE INVENTION

Cup or bowl shaped edible containers have become common over the last few years. One type of edible container, made from a dough forming a bread-like container has been used for containing salads, soups and other comestible materials. Such bread bowls can be made by forming dough into a bowl-shaped structure and then baking the product to a final form. Alternatively, conventional, generally oval or spherical loaves are baked, the interiors are cut or scooped out and the hollowed loaf is then used as a “bread bowl”. This technology has become more and more common. Such bread bowls are shown in Ruiz, U.S. Pat. Nos. 4,873,099, 5,002,783 and 5,128,157; and Bank, U.S. Design Pat. No. 277,234. The products can be made in an apparatus such as that shown in Tienor et al., U.S. Pat. No. 5,072,664; Savage, U.S. Pat. No. 5,400,698; Ellner, U.S. Pat. No. 5,601,012; Woods, U.S. Pat. No. 5,974,934 or Bastasch et al., U.S. Pat. No. 6,042,864. These products have some value in the production of edible materials, however these products are limited in their overall shape and size. Substantial need still exists in providing a variety in container size, product, versatility and improved production methods.

### BRIEF DESCRIPTION OF THE INVENTION

An edible container for human food can be made in the form of an enclosed manifold. A manifold is a substantially enclosed volume with an arbitrary shape or geometry. The food manifold is made with an enclosed internal void space that once opened, can act as a container or reservoir for an arbitrary quantity of food. The container is configured and used by removing a portion, substantially less than half of the surface area of the manifold revealing an interior container volume shaped to contain an appetizer, a serving size portion or two or more portions of a food material. A section of the manifold is removed to reveal the internal volume. This section is a part of the manifold comprising an area of 0.01 to 30% preferably 0.1 to 20% of the manifold surface area. In the instance that the manifold is substantially spherical, the sector can have a curved shape that is generally circular in profile. The radius of the circle defined by the sector typically is less than the spherical radius of the substantially spherical manifold and is commonly less than 0.7 times the spherical radius. A variety of foods can be introduced into the interior volume of the edible container for consumption. The container and its constituent material is formulated and is structurally configured for resisting any reduction in container strength, appeal or structural integrity when filled with a hot or cold, liquid or solid food substance. During consumption of the food contents of the container, the edible container can also be consumed. In one embodiment the interior of the manifold can contain a separate comestible object.

The container typically comprises a shell of an edible substance and the dough or the interior surface can optionally contain a moisture barrier to maintain the structural integrity of the sphere during the time it contains the food material by slowing the rate moisture penetrates the container. Preferred moisture barriers are hydrophobic. The manifold container is shaped and sized to contain an appetizer portion, at least an individual serving size portion, and can contain sufficient food to satisfy two, three, four or more individual members. Once the food in the container is consumed, the shell can be divided into portions for individual consumption. The food adapted for use in the shell can comprise a breakfast food, a snack food, a brunch food, a lunch food, a dinner food, a dessert food, or any other typical consumable material. Such food can be liquid, a blend of liquid and solid materials, thickened liquids, gels, semisolids or solids of varying particle size or unit size. The container can be made with a unique edible item held inside the manifold. This item can be removed and consumed separately as a bonus item.

Such edible containers can be made for retail sale in a frozen form, can be made available to restaurants in a frozen form or can be manufactured in food production facilities into a final baked container. These product combinations can be packaged with a food material in a separate container for preparation and introduction into the manifold at the time of consumption.

The manifold of the invention typically has an internal volume of at least 10 cm³ and can have a volume that ranges from about 15 to about 8000 cm³. The wall thickness of the manifold is typically greater than about 0.1 cm, but can range from about 0.2 to about 10 cm typically 0.3 to about 5 cm. The manifold can have an internal void space that has the fugitive material with a radius of at least 2 cm, but often ranges from about 3 to about 50 cm commonly 5 to about 20 cm. The internal surface of the manifold can be coated with a hydrophobic moisture barrier that can help preserve the container, once formed, from the undesirable effects of the food material within the container.

The edible manifold container can be made using a variety of materials formed with a variety of techniques. The manifold can be made by forming a production unit comprising unbaked edible material surrounding a fugitive center composition and baking the unit. The unit forms an interior space for the food.

The manifold of the invention can be made from a dough mixture made from wheat, corn, rye or other common flours and can be made in a sweet, bready, cake-like or other formulation. The only requirement of the formulation is that it can be either formed over a fugitive material or inflated using the inflation techniques disclosed below. The dough formula commonly used for this material typically comprises 40-60 wt % flour, 45-65 wt % water, 0-30 wt % sugar, 0 to 5% salt, 0-12% shortening, 0-5% yeast and chemical leavening, both single action and double action baking powder either in the dough formula or in the inflation section of the dough portion. The fugitive portion of the invention can be a fully fugitive material or a partially fugitive material. A fully fugitive material is one that leaves no substantial amount of residue after the dough ball is formed. A partial fugitive material is a material that leaves at least some substantial portion of material remaining in the dough ball after dough ball formation. The partial fugitive material can be a desirable edible portion such as cheese, a second baked item such as a roll or a baked meat portion or any other material that can be combined with the fugitive or inflatable material during manufacture of the dough ball. Such partial fugitive materials can be made by introducing a bakable material with, for example, a dry ice charge resulting in the dry ice leaving substantially no residue upon evaporation but leaving any food item placed within the manifold intact within the manifold. Such portions can be sized and configured such that the portion can be fully cooked as the manifold is also baked to completion.

The manifold container of the invention is typically made using one of two basic methods. In one alternative, the dough can be formed over a fugitive shape using a variety of techniques, the dough and baked fugitive material is removed from the interior using a variety of techniques leaving a substantial void inside the baked manifold that may or may not contain additional materials. In a second alternative, the bread dough is formed into a shape of a bread bowl optionally having a small interior void and then the bread bowl is inflated to form a manifold. The inflation of the bread bowl can be done using a variety of techniques including chemical agents that can form an inflating gas, an inflating gas can be injected into the interior of the bread bowl or into the small void, or through the use of any material that can form or introduce an inflating gas within the dough ball.

The unique edible container of the invention has a unique exterior or interior shape that can be obtained by inflation or formed using the fugitive insert. A unique exterior shape can be formed by cooking the dough ball within a cooking chamber that presses a unique shape into the dough ball exterior. A unique interior can be formed by using a fugitive material having a shaped form leaving the desirable shape in the form of the interior after the fugitive material is removed. The open container is made by forming an upwardly facing opening in the manifold by removing a portion of the manifold. Once the manifold is made, the opening can be formed in the unit in a variety of ways, but typically is made by removing a section from the manifold and placing the containers in an upwardly facing position. Preferably, a stable base on the bottom is also formed during formation, baking or during opening. Upon baking, the exterior layer cooks to form a manifold of structural integrity while the fugitive center changes state and leaves an interior volume substantially free of the fugitive material. The interior can be adapted to contain the food once the spherical container is prepared for serving.

The uncooked manifold can be baked or parbaked from an unbaked production unit that is manufactured by inflating a dough ball or a dough ball with an intentionally formed small void within the dough ball. The dough ball is combined with an inflating means such as a probe or needle shaped object that can be inserted into the interior of the dough ball to introduce the inflating gas. The inflating gas can be introduced into the dough ball until the dough ball is inflated to the appropriate shape or size, the shape or size of the dough ball can be defined by a form that can surround the dough ball prior to inflation and can limit the inflation of the dough ball to a particular shape or size. Such a form can be combined with a vacuum source that can aid in forming the dough ball against the form using the reduced pressure to promote contact with the form.

The uncooked manifold can also be baked or parbaked from an unbaked production unit that can be manufactured with an exterior layer of an uncooked material, an interior fugitive layer or composition. Between the fugitive layer and the exterior layer, a moisture barrier material can be formed. Alternatively, the moisture barrier material can be incorporated into the fugitive composition. After the fugitive composition changes in state, the barrier material becomes an interior layer within the shell. The layer results from the change in state by the fugitive material. In one embodiment, the production item can be made by forming the unbaked food material over a substantial portion of the fugitive composition, leaving a portion of the fugitive material exposed. Once baked the interior volume is revealed as the fugitive material changes state and is removed from the interior. Such a layer can be formed substantially on the surface of the interior of the spherical container with little or no penetration into the container. The barrier can also be incorporated into the interior surface of the container. Such a barrier layer, regardless of placement, can be 0.1 to 5 mm in thickness preferably 0.2 to 3 mm in thickness.

A serving portion of a food in the container can be made by first preparing the edible container. The unbaked material comprising the cookable exterior and the fugitive interior composition can be baked at a temperature sufficient to cook the exterior material and render that material with sufficient structurally integrity to support its own weight and the weight of the food placed within the container. The cooking also causes the fugitive material within the item to change in state and leave the interior void volume for the introduction of the food material. Once the cooking of the container is complete, the upwardly facing opening can be formed. One important aspect of the manufacture of the edible container is the nature of the interior of the structure. Since the structure is made with the process disclosed herein, the interior structure forms a baked surface layer. The surface layer is not an open cell, baked structure similar to that interior structure formed by cutting into a bread-like material, but is a surface layer not unlike the formation of a substantially continuous crust-like layer. The interior layer can be improved by forming a moisture barrier composition on the interior layer. Extruding the moisture barrier between the uncooked exterior portion and the fugitive layer during manufacture can form such a barrier. Alternatively, the moisture barrier can be incorporated into the fugitive composition such that, as the fugitive composition changes in state, the moisture barrier layer forms on the interior surface of the spherical edible material. The term “manifold” refers to an enclosure of any arbitrary shape or geometry. The manifold can be regular in shape like a sphere, egg-shape, square, etc. The manifold can be irregular in shape. The manifold must have an internal volume sufficient to contain at least an appetizer portion of food, but can also contain a full serving or two or more serving size portions of a food. The manifold typically encloses a volume without substantial openings from the interior to the exterior. The manifold is typically formed by crimping or sealing a structure with openings to an internal volume, sealing and separating the volume from the exterior.

### BRIEF DESCRIPTION OF THE DRAWINGS

FIG. 1 is an exterior view of the spherical container of the invention prior to forming an upwardly facing opening, but after cooking.

FIG. 1a is a cross-sectional view of the item of FIG. 1. The cross-sectional view shows the interior volume formed for the food item.

FIG. 2 shows forming the upwardly facing opening in the container by removing a section of the sphere along line A.

FIG. 3 is an alternative embodiment of the container of the invention using a portion of the sphere that is somewhat less than half of the original sphere.

FIG. 4 is a depiction of the unbaked item of the invention having the exterior unbaked portion surrounding the fugitive composition (in phantom). In FIG. 4, the fugitive composition is entirely held within the perimeter of the unbaked material.

FIG. 5 is a depiction of the use of a extruder to form an external dough layer with a co-extruded internal filling portion. The extruded dough and internal portion are then crimped to form an uncooked manifold substantially completely surrounding the interior portion which can then be baked as needed.

FIG. 6 is a depiction of the use of an inflating gas to form the dough ball manifold.

FIG. 7 shows a process for forming the manifold using two layers of dough and the fugitive material formed there between.

FIG. 8 is a depiction of one way to form the manifold using a single circular portion of the dough formed into a manifold surrounding an interior filling portion.

FIG. 9 is a depiction of an apparatus that can be used to automatically insert a probe into the dough ball and inflate the dough ball into a manifold with an internal void.

FIG. 10 is a depiction of heated spheres that can be used to cook a dough ball with or without a fugitive center. The use of high heat and rapid cooking can come as a result of the formation of gases held within the dough ball can form the manifold without the use of a fugitive material. However such a heated sections can also be used to form the dough ball with the injection of an inflating gas within the dough ball and using a fugitive material.

FIG. 11 is an alternative embodiment of apparatus that can be used to close a circular section of dough around a fugitive material prior to baking.

### DETAILED DESCRIPTION OF THE INVENTION

The manifold container of the invention comprises an exterior portion made from a baked food with an interior void. A variety of baked foods can be used to form the exterior shell. Such foods include breads, including wheat breads, corn breads, cakes and other breads made using a variety of flours.

Any typical cake or bread formulation can be used in this invention, however, the formulation used for this product is designed to have an open cell structure and be reminiscent of home baked bread. The product shape is optional and can be spherical, oval, loaf-like, etc. The texture closely resembles the traditional bread product. Neither this shape nor open crumb can be obtained with the bread bowl products that are formed and molded over a bread pan.

The manifold of the invention can take virtually any arbitrary shape or size that is convenient for conversion into a container for food disclosed herein. The manifold can be circular, oval, rectangular, pyramidal or other convenient geometric shape. The manifold can be arbitrary multi-lobed, convex, concave or other arbitrarily shaped attribute surface manifold. Regardless of the regular or irregular shape of the manifold, the manifold is typically converted into a container by removing a portion of the manifold leaving an opening that is placed in a substantially upright position. Typically, an amount of the manifold is reduced such that the major dimension of the opening (the linear dimension across the opening that has maximum length as measured from edge to edge) is typically less than the major dimension of the manifold. In the case that a substantially spherical manifold is used, the radius of the opening is typically less than the radius of the substantially spherical shaped manifold. As a result, the manifold is typically inwardly sloped towards the opening of the manifold. While under certain circumstances, the manifold can be cut neatly in half to produce two similarly shaped containers. A preferred mode of opening the container is to remove a relatively small portion of the manifold leaving a substantial proportion of the manifold as the container. Once the food is placed within the manifold container, then the removed portion can be replaced for aesthetic purposes or can be discarded as desired.

Foods that can be used to fill the container in the invention include any food normally consumed by human individuals including breakfast items, lunch items, dinner items, snack items, brunch items, dessert items and other materials. Typical breakfast items include egg preparations such as scrambled eggs or poached eggs, omelet materials or scrambled eggs combined with vegetables, meats or other flavorings and condiments. The container can be used to contain cereals such as oatmeal, cream of wheat, dry cereals combined with milk, müsselix, fruits, yogurts, etc. Such foods can be cooked, uncooked, raw or otherwise prepared for use. Lunch items that can be used in the container of the invention include soups, stews, chili, salads, prepared meats, seafood, sandwich fillings such as chicken salad, ham salad, crab salad or other combinations of proteinaceous foods, vegetables and dressing. Dinner items that can be consumed using the container of the invention the typical lunch items and also include larger proportions of such items and other types of prepared meats, fish, poultry, vegetarian foods, tofu, etc. The containers of the invention can also be used as dessert items by containing fruits, chocolate, puddings, frozen items such as ice cream, custards, English truffle, and other such dessert-like materials. In such an application, a formulation for the exterior portion of the container of the invention can be made from a richer recipe including substantial amounts of butter, sweetener or other lighter or more dessert-like texture, flavor or character.

The bread bowl container of the invention is adapted for containing a liquid or substantially liquid food such as a soup or stew type of food. The preferred liquid food is formulated to provide a selected viscosity to help maintain the visual attractiveness and structural stability of the container. A reduced viscosity food would tend to cause penetration of the container by moisture that can soften and reduce structural integrity. The preferred viscosity reduces the rate the liquid material penetrates the hydrophobic layer and the bread layer.

As a result of one aspect, the manufacturing process of the container of the invention, the interior surface (see surface 14, FIGS. 1a, 2 and 3) can obtain a unique character. First, after the disappearance of the fugitive composition, the interior layer will be cooked by the thermal energy of the cooking process. The internal surface will, somewhat similar to the exterior surface but to a lesser degree, form a crust-like layer that cooperates with the interior bread-like portion of the container and the exterior crust to provide structural integrity. Further, the interior crust-like layer provides some inherent moisture resistance to the structure. Such characteristics can also be introduced with choice of the recipe for the dough. The interior layer is not an open cell bready-like layer, but is a continuous closed surface somewhat resistant to absorption of liquids from the contained food materials. Further, the interior surface is different than a surface that can be manufactured by forming a dough layer on a form and baking that form. Such dough layers typically cook and pull away from the form typically forming an outwardly extending edge in a somewhat V-shaped or U-shaped cross-sectional form. Such containers will formed with an interior glass metal form that must be removed before use. The removal process of such a form will likely distort the container from its original form to a form having an opening that is equivalent to the major dimension of the opening of the container. The surface of the invention is different than the surface of a cut layer formed by cutting a portion of bread from a loaf to form an interior zone. Such a cut layer is an open cell bread layer typical of cut bread.

One aspect of the invention resides in a fugitive composition that is formed in the center of the unbaked production item of the invention. Baking the item at elevated temperature forms or makes the container-like nature of the spherical container of the invention. The temperature of baking, proofing, or resting causes a change of state of the fugitive composition such that the fugitive composition substantially leaves the interior of the spherical container leaving the container with an interior void or volume. Such change in state can comprise a change from a solid or semisolid to a liquid form or a change from a solid or semisolid to a gaseous form or a combination of both changes in state. In the event the fugitive composition changes state into a gaseous form, such a form can comprise water vapor, carbon dioxide, nitrogen, or other gaseous materials that can arise from a solid state. Should the fugitive composition melt into a liquid that can then be absorbed by the container or drained from the container during cooking. High melting solids such as lipids, etc. can be used to form the interior fugitive material in the invention.

An essential aspect of the fugitive material of the invention is that during cooking, at least a portion of the fugitive composition changes in some aspect of its original state and leaves a void or open space sufficient to accept at least a single-sized serving portion, or more, within the spherical container into which a food material can be placed. The material can change in density, from solid to liquid, from solid to gaseous, from a foam to unfoamed liquid, from a high viscosity liquid (preferably, with sufficient viscosity to exist as a glassy liquid) to a low viscosity liquid, and other changes that can help to create a void. An additional feature of the fugitive material in the invention is a material that can maintain a structure of the bread until the bread formulation gelatinizes or crusts to a sufficiently strong self-supporting material.

The production item of the invention can contain a chemical leavening agent that produces a leavening gas such as carbon dioxide during heating in cooperation with the fugitive composition. The leavening agent can be tailored to produce a pressurizing gas at one or more desirable temperature(s). Such a temperature can be coordinated with the melting point of the sphere or can be selected to release gas at any arbitrary temperature above room temperature once baking begins.

Specific examples of fugitive compositions that can be used within the container of the invention include a hollow spherical material made of a high melting composition. Such a sphere melting at a temperature greater than about 150° F. (about 65° C.), preferably about 180° F. to 220° F. (about 80° C. to 105° C.) can maintain the dough structure until baking raises the temperature of the sphere above its melting point. At that point, the sphere would melt and either drain from the sphere or be absorbed by the bread baking product.

One aspect of the baking composition can comprise a solid spherical object of relatively low density. Such a light or low-density sphere can be made from a foamed material having air bubbles of any arbitrary size.

The property of the foam is simply that it should be maintained in a structural manner until the exterior surface of the container has been cooked sufficiently to maintain its shape and interior void or volume. One aspect of maintaining the structure of the container is simply to inject an air bubble or pocket within the dough prior to baking. The dough formulation is selected such that the air bubble or pocket will be maintained until the dough is baked sufficiently to form the container. Such air injection can be combined with the introduction of chemical leavening material that is selected to generate gas at one or more temperatures during the cooking process. The chemical leavening agent can be engineered to generate its gas quickly at a relatively low temperature during the baking process, at a relatively high temperature near the end of the baking process or at intervals of temperature as the temperature of the baked item increases during cooking. In other words, the first chemical leavening agent can produce gas at a relatively low temperature, i.e. about 120° F. (49° C.)-400° F. (204° C.) but then can produce additional amounts of leavening gas at temperature intervals of about 2° F. (1° C.), 5° F. (2° C.), 10° F. (3° C.), 25° F. (13° C.), etc. during the baking process. Such a baked product typically experiences a range of temperature from about ambient, i.e. 70° F. to 90° F. (20° C. to 35° C.), up to the final temperature of the baked product which generally has a crust temperature from about 320° F. to about 380° F. (160° C. to 195° C.). Using a blend of a variety of leavening agents that produce gas set temperatures during the baking process can help maintain the interior volume during baking.

A foamed material that can be used as the interior fugitive composition includes foams made by foaming egg whites such as a meringue, foamed gelatin, foamed lipid materials using food grade surfactants optionally or other materials. One advantage of the foam material was the tendency of such a foam to break and result in a foam residue of relatively little mass compared to the foam volume. Such a foam would have relatively low density and a high included air to solids ratio. The specific gravity of such a foamed material should be less than about 0.3, typically about less than about 0.25.

### DETAILED DESCRIPTION OF THE DRAWINGS

The following drawings demonstrate an illustration of various aspects of the invention. While these aspects may constitute a best mode of the invention, alternative embodiments of the invention can be made without departing from the spirit and scope of the invention. Common numbering is typically used for common elements.

FIG. 1 is a side view of a baked spherical container of the invention prior to formation of the interior food space. The baked item 10 entirely includes the internal volume 11 formed within the shell 10.

FIG. 1a is a cross-sectional view of the spherical baked item of FIG. 1 along line A. In FIG. 1a, the baked item 10 is shown in cross-section comprising an interior surface 14, an exterior surface 13 and the width of the baked shell 12. Wholly enclosed within the item 10 is the interior void volume or space 11.

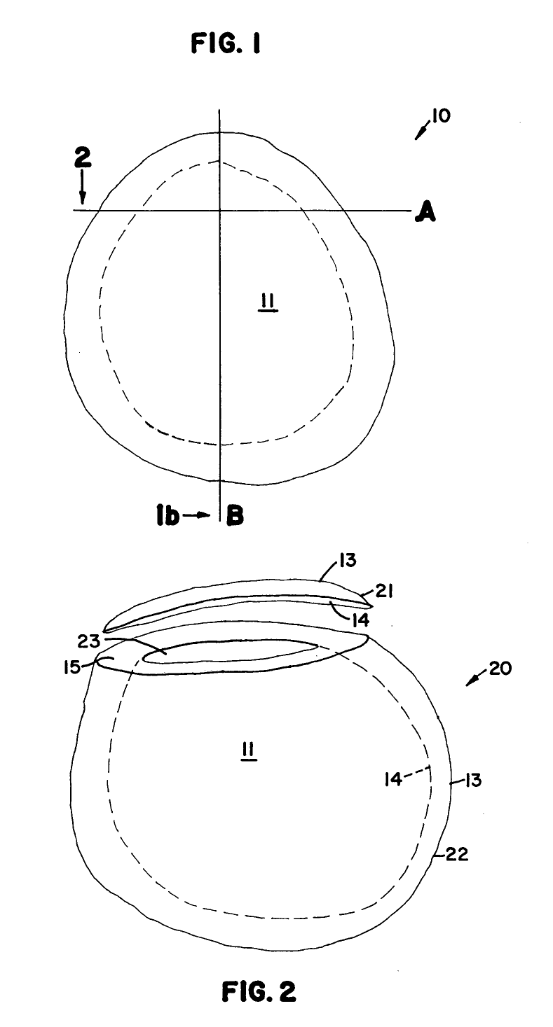

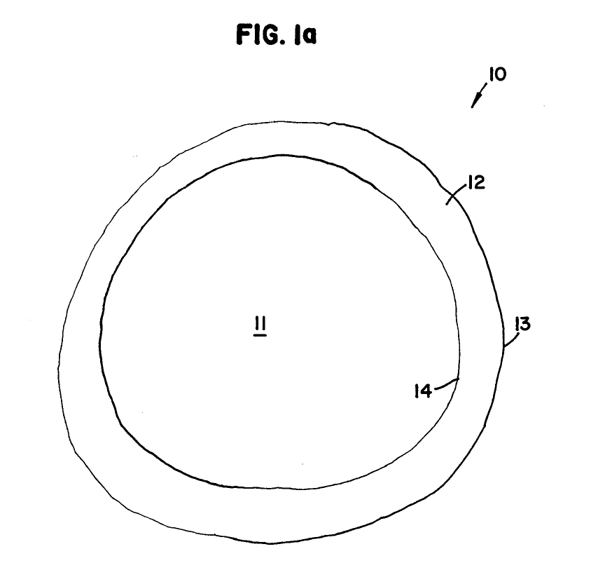

FIG. 2 is a cross-sectional view of the spherical baked item of FIG. 1 along line B. FIG. 2 shows a first embodiment of the container of the invention. In FIG. 2, a container 20 is shown in two parts; a section portion 21 and the container portion 22. The container portion 22 has an exposed edge 15. The container also has an exterior surface 13 and an interior surface 14 forming the interior void volume 11 within the container 22. The section 21 is removed from the sphere forming the upwardly facing opening 23. The section 21 additionally has an interior surface 14 and exterior surface 13 formed as the unit is baked. The section 21 is removed from the spherical container by forming a section along line A removing the section from the spherical unit.

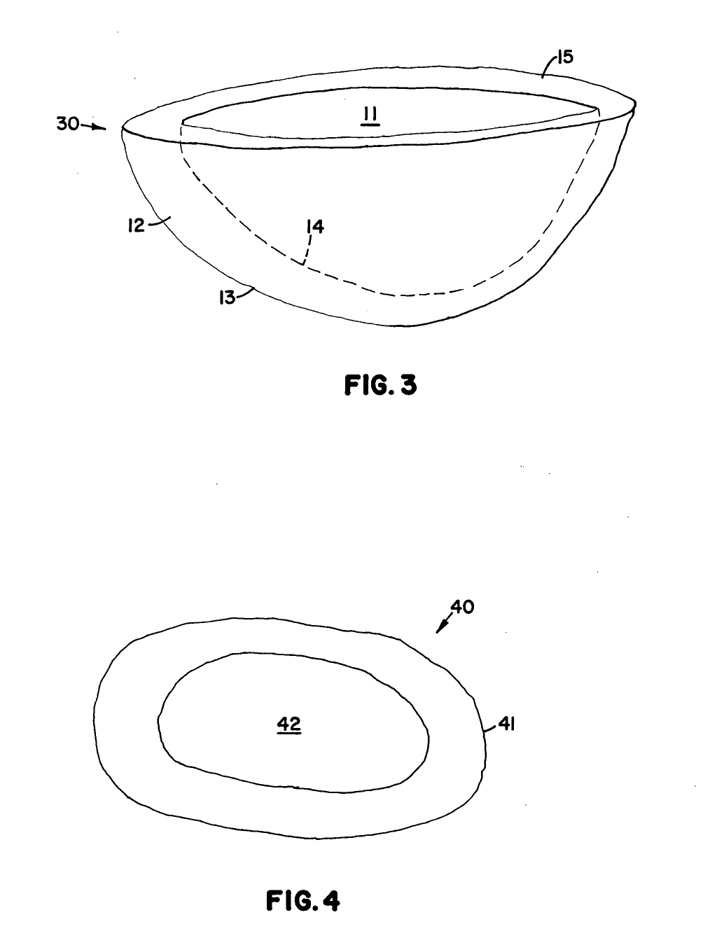

FIG. 3 shows an alternative embodiment of an edible container 30 of the invention. Container 30 comprises less than half of the spherical baked item. Container 30 is made by removing greater than half of the spherical member leaving the container 30 for use in containing a food substance. In forming the container 30, an exposed edge 15 is formed in the spherical layer, the exposed surface is a bready open celled layer typical of baked goods. The container 30 comprises an interior layer 14, an exterior layer 13 and an interior bready portion 12 forming the spherical member. The structure contains the interior volume 11 in which the food item can be placed.

FIG. 4 illustrates the unbaked production item used to form the container of the invention. The unbaked item 40 comprises an exterior shell of an unbaked material 41 that entirely contains and surrounds the fugitive composition 42. Cutting the production item substantially in equal halves can lead to making hemispherical containers. The halved production unit then reveals the fugitive composition and baking the portions into containers results in a halved spherical container.

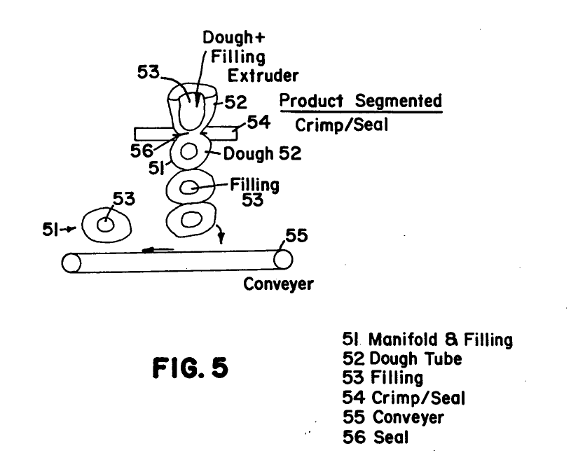

FIG. 5 illustrates one method of manufacturing the manifold with a fugitive filling held within the unbaked manifold. A food grade extruder device (not shown) that can create an interior filling extrudate 53 surrounded by an exterior cylindrical dough extrudate 52 is used to form dough 52 surrounding the filling portion 53. The external dough tube is then crimped and sealed, holding the filling inside, using a crimp device 54. The crimp seal device 54 converts the dough tube 52 into the manifold 51 surrounding the filling of 53 by forming a seal 56 that completes the compression and sealing of the dough ball surrounding the filling 53. Once the complete manifold 51 and filling 53 are formed, the individual manifolds 51 can be separated, if necessary, and conveyed to storage, a freezer, or a baking section. In this figure, the extruder and the baking freezer or storage section are not shown.

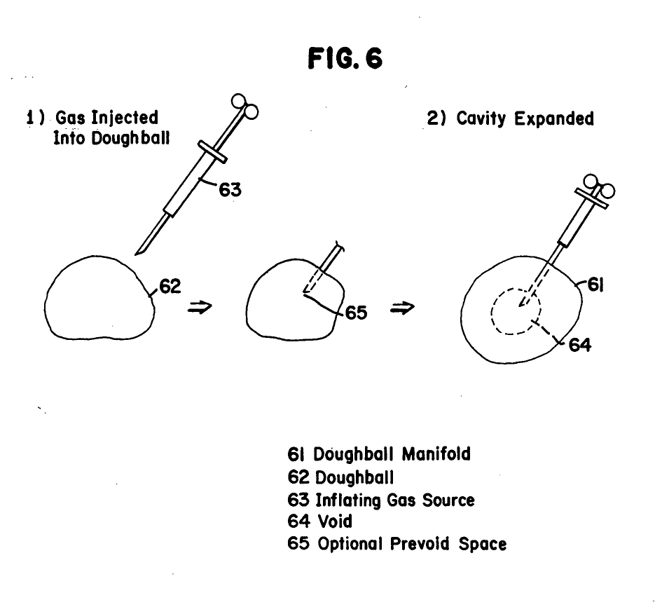

FIG. 6 illustrates a method for using a gas injector to inflate a dough ball into a manifold. The dough ball 62 can have an optional internal space 65. A dough ball 62 is formed that may have an optional space 65 formed in the dough ball. A gas injector 63 comprising a source of inflating gas can be inserted into the dough ball 62 or optionally into the preformed space 65. The inflating gas is introduced into the dough ball and the cavity is expanded to the size of a desired void 64 forming the manifold 61. After inflating, the manifold is then stored or baked as desired. The storage or baking units are not shown in this figure.

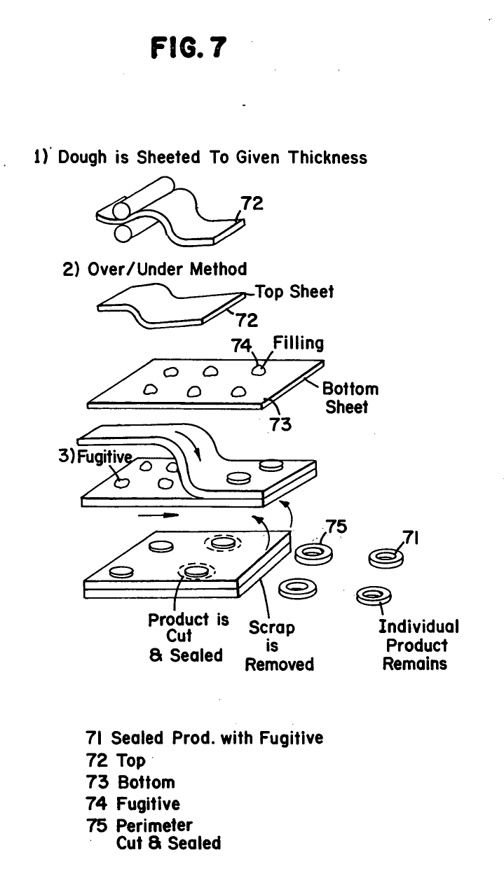

FIG. 7 illustrates a method of forming the manifold of the invention by forming two sheeted layers of dough 72, 73 placing the fugitive material 74 between the sheets of dough 72, 73 sealing the perimeter of the dough sheets surrounding the fugitive material and cutting of the sealed product from the sheeted form. The individual portions can then be baked. In FIG. 7, the first dough sheet 72 and a second dough sheet 73 comprising a bottom sheet are formed. The fugitive material 74 is placed on the bottom sheet 73 as desired. The top sheet 72 is then placed on the fugitive material and bottom sheet and the dough is sealed around the fugitive material completing enclosing the fugitive material within the dough layers. The sealed sections comprising the dough sheets 72 and 73 and the fugitive material 74 are then cut into a sealed product with the fugitive material 71. The perimeter of 75 surrounding the fugitive material is sealed sufficiently that the product can be maintained in a sealed fashion during manufacture or storage and will survive cooking into the manifold structure of the invention.

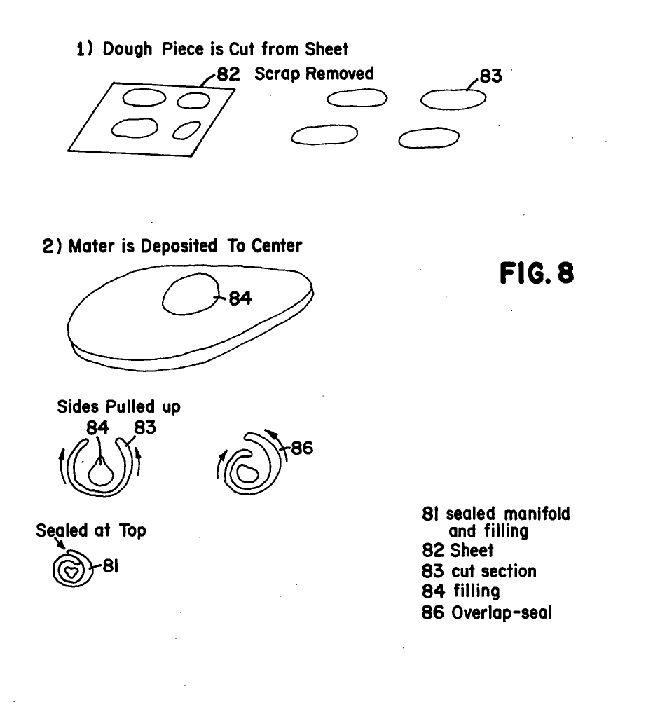

FIG. 8 illustrates the method of manufacture of the manifold of the invention using a single circular dough sheet 83 and a fugitive filling 84. In the method, a sheet of dough 82 is conveyed to a cutter that can form a circular portion of dough 83. The fugitive filling 84 is placed on the circular portion of dough 83 and the perimeter of the circular portion 83 is drawn around the fugitive center 84 until the dough material is completely sealed fully surrounding the fugitive material. In this process the filling 84 is surrounded by the cut section 83 using sealing means (not shown) that forms the dough 83 around the fugitive center 84 using an overlap seal 86. Such a method will inherently form a non-spherical somewhat rough final product.

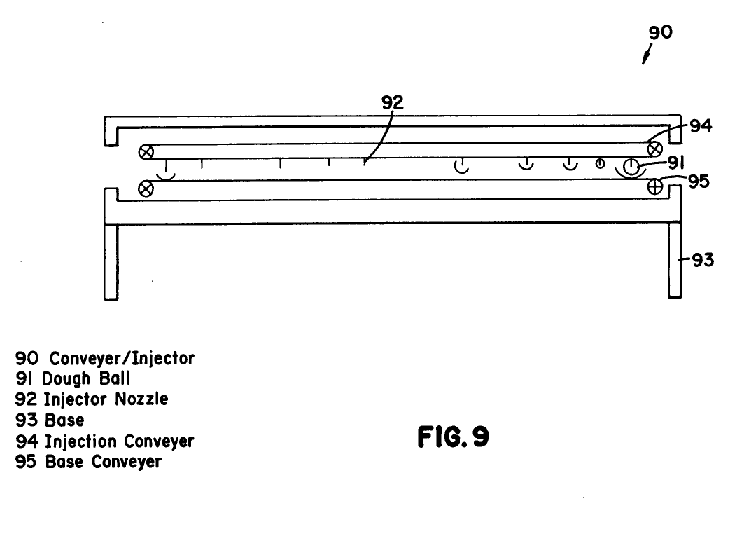

FIG. 9 illustrates manufacturing equipment that can be used to automate and continuously manufacture the inflation of the dough ball using an inflating gas. The equipment is formed on a base 93 that supports a bottom conveyer base or bottom conveyer 95 upon which the dough balls are placed. As the conveyer 95 moves the dough ball 91 along the conveyer path, the dough ball 91 comes in contact with injector nozzle 92 installed onto conveyer 94. As the injector nozzle 92 enters the dough ball 91, the inflating gas is introduced directly into the dough ball or into an optionally formed void within the dough ball and then effectively inflate the dough ball into a manifold. The source of gas, post inflation equipment and the dough ball cooling, conveying and storage equipment are not shown in the figure.

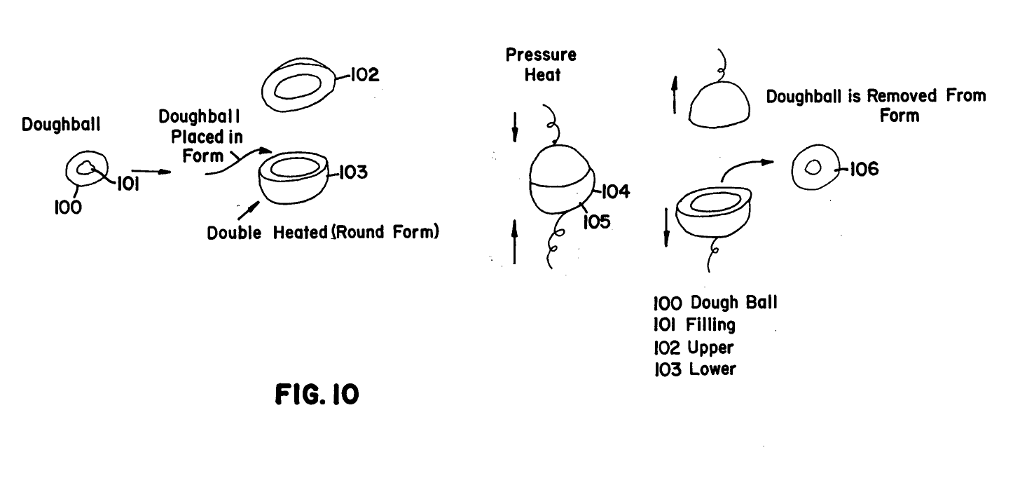

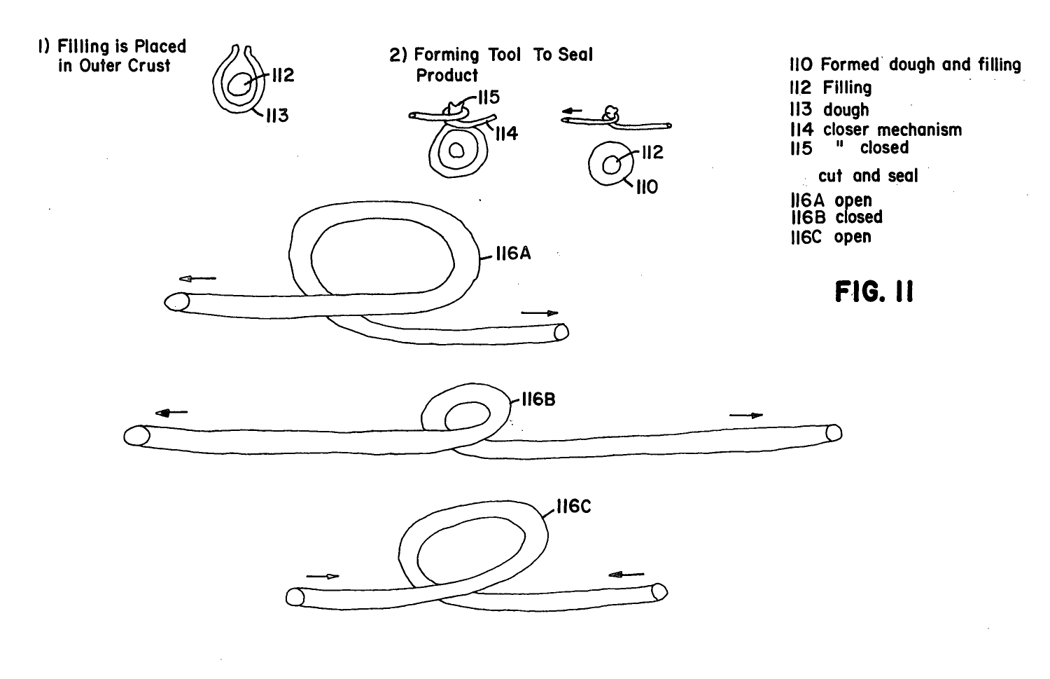

FIG. 10 illustrates the use of heated mold or molding spheres for the purpose of forming and optionally cooking the manifold. In FIG. 10, a dough ball 100 containing a filling 101 can be prepared. The prepared dough ball 100 and filling 101 can be inserted into the interior space of two hemispherical heated round forms 101 and 102. The forms can be closed to form a closed heating vessel 104. The heating vessel 104 can be heated optionally using a variety of techniques including electric heating, steam heating or otherwise. Additionally, the vessel can comprise the source of optional vacuum that can aid in forming the dough ball to the perimeter of the vessel 104 using reduced pressure aiding the influence of the inflating gases. Once cooked, the upper and lower forms of 102 and 103 are separated and the dough ball is removed from the forms. The manifold generally is in the shape of the forms which can also take a variety of forms depending on the desire of the engineer.

FIG. 11 is a further embodiment of a method of closing and sealing a dough layer into a manifold surrounding a center fugitive material. And then an initial dough structure can be formed using the dough 110 and the filling 112. The perimeter of the dough can be assembled and inserted into a closure loop 114 that closes and seals the dough with a closure system that simultaneously cuts and seals the assembled edges of the dough section. The resulting structure is a formed manifold 110 with the internal filling 112. The closure mechanism is shown as an open structure 116A a closed structure 116B which can be reopened to the open structure 116C using a resilient metal structure.

The following Examples demonstrate various ways of preparing the manifold and the container of the invention. As discussed above, the manifold can typically be made by forming the manifold over a fugitive material, co-extruding the manifold over a fugitive material, forming and wrapping a dough layer over the fugitive material, injecting air into a preformed dough ball that can optionally contain a pre-void space, rapidly baking a dough ball, i.e. like a puff-pastry recipe and preparation method using an edible internal shell made of an edible material such as carboxy methyl cellulose, kiton or other edible substances or by using a co-extruded foamy filling made from egg white, or other edible foam compositions. The following Examples are not meant to limit the scope of the invention, but simply to illustrate the various methods of manufacturing the manifold.

### EXPERIMENTAL SECTION

### Example 1

### Dry Ice Method

1. Pre-weigh ingredients.

| | | |
|---|---|---|
| Patent Flour | 1300.0 | g |
| Salt | 12.4 | g |
| Sugar | 26.0 | g |
| Instant Dry Yeast | 20.0 | g |
| Pastry Shortening | 52.0 | g |
| Water | 750.0 | g |

2. Add ingredients into an 8 L stainless steel mixing bowl.
3. Mix dough on low setting (100) for 2 minutes and medium setting (200) for 7 minutes in a Welbilt Varimixer (model W20A) with spiral mixing arm.
4. Cut dough into 174 g samples.
5. Round dough balls.
6. Allow dough balls to rest for 5 minutes.
7. Press dough into a thin sheet (about 6″ diameter and ½″ thick).
8. Place thin layer of water around outer edge (to aid in sealing).
9. Add 2.0 g of dry ice (blasting rice from Jason's Dry Ice) to center of sheet.
10. Wrap and seal edges so no leaks occur. As dry ice sublimes it will inflate the dough ball to the desired volume.
11. Place inflated dough balls on baking sheet when at maximum diameter.
12. Bake in preheated Gemini revolving rack oven at 450° F. for 9 minutes (or until crust is golden brown).

This results in a hollow spherical bread bowl with a flat bottom. Hollow spherical bread bowl can be frozen to extend shelf life. Prior to eating, simply cut a 2″ to 4″ hole in the top (forming a lid), remove the lid, and add soup/salad/ice cream/etc.

### Example 2

### Chemical Leavening Method

1. Pre-weigh ingredients.

| | | |
|---|---|---|
| Patent Flour | 1300.0 | g |
| Salt | 12.4 | g |
| Sugar | 26.0 | g |
| Instant Dry Yeast | 20.0 | g |
| Pastry Shortening | 52.0 | g |
| Water | 750.0 | g |

2. Add ingredients into an 8 L stainless steel mixing bowl.
3. Mix dough on low setting (100) for 2 minutes and medium setting (200) for 7 minutes in a Welbilt Varimixer (model W20A) with spiral mixing arm.
4. Cut dough into 100 g samples (60 g-174 g).
5. Round dough balls.
6. Allow dough balls to rest for 5 minutes.
7. Press dough into a thin sheet (about 6″ diameter and ½″ thick).
8. Shape dough sheet into shallow cup (about 2″ diameter with 2″ tall lips).
9. Place thin layer of water around outer edge (to aid in sealing).
10. Form slurry by mixing 3.0 g double action baking powder (DABP) and 3.0 g water.
11. Add slurry into center of dough cup.
12. Seal edges so no leaks occur.
13. Optionally proof the dough balls for 0-45 minutes at 90° F. and 95% relative humidity.
14. Place inflated dough balls on baking sheet. DABP will react and inflate the dough ball with gas.
15. Bake in preheated Gemini revolving rack oven at 450° F. for 9 minutes (or until crust is golden brown).

This results in a hollow spherical bread bowl with a flat bottom. Hollow spherical bread bowl can be frozen to extend shelf life. Prior to eating, simply cut a 2″ to 4″ hole in the top (forming a lid), remove the lid, and add soup/salad/ice cream/etc.

### Example 3

### Air Injection Method

1. Pre-weigh ingredients.

| | | |
|---|---|---|
| Patent Flour | 1300.0 | g |
| Salt | 12.4 | g |
| Sugar | 26.0 | g |
| Instant Dry Yeast | 20.0 | g |
| Pastry Shortening | 52.0 | g |
| Water | 750.0 | g |

2. Add ingredients into an 8 L stainless steel mixing bowl.
3. Mix dough on low setting (100) for 2 minutes and medium setting (200) for 7 minutes in a Welbilt Varimixer (model W20A) with spiral mixing arm.
4. Cut dough into 174 g samples.
5. Round dough balls.
6. Allow dough balls to rest for 5 minutes.
7. Press dough into a thin sheet (about 6″ diameter and ½″ thick).
8. Shape dough sheet into shallow cup (about 2″ diameter with 2″ tall lips).
9. Insert a straw into center of cup. Wrap edges of dough tight around straw.
10. Take a deep breath and blow air into the dough using the straw. Inflate to desired volume (about 6″ diameter sphere).
11. Remove straw and seal exit hole so no leaks occur.
12. Place inflated dough balls on baking sheet.
13. Bake in preheated Gemini revolving rack oven at 450° F. for 9 minutes (or until crust is golden brown).

This results in a hollow spherical bread bowl with a flat bottom. Hollow spherical bread bowl can be frozen to extend shelf life. Prior to eating, simply cut a hole in the top (forming a lid), remove the lid, and add soup/salad/ice cream/etc.

### Example 4

### Co-Extrusion Method

1. Prepare Rheon KN400 encrusting machine by installing the 24 mm inner nozzle, 50 mm outer nozzle, and 4YD2 encrusting shutter. Remove all piping for the inner filling port and leave it open to the atmosphere.

2. Pre-weigh ingredients.

| | | |
|---|---|---|
| Patent Flour | 30.09 | lb |
| Salt | 0.29 | lb |
| Sugar | 0.60 | lb |
| Instant Dry Yeast | 0.46 | lb |
| Pastry Shortening | 1.20 | lb |
| Water | 17.36 | lb |

3. Add ingredients into an stainless steel mixing bowl.
4. Mix dough on low setting for 200 sec and high setting for 600 sec in a VMI SPI 120FE mixer with spiral mixing arm.
5. Rest dough for 15 minutes.
6. Add dough into the hopper on Rheon KN400 encrusting machine.
7. Set Rheon controls to 40.0/0.0/3.0/20 (dough/filling/shutter/belt)
8. Turn on the Rheon. The vane pump will fill with dough and it will start flowing through the outer nozzle.
9. Hand dump 2.0 g of dry ice into the inner filling port. Time the addition to coincide with the encrusting shutter motion. The dry ice will fall into the center of the extruded dough where it is subsequently crimped closed with encrusting shutter.
10. Remove inflated dough balls from the conveyor belt and place on a baking sheet.
11. Bake in preheated Gemini revolving rack oven at 450° F. for 9 minutes (or until crust is golden brown).

This results in a hollow spherical bread bowl with a flat bottom. Hollow spherical bread bowl can be frozen to extend shelf life. Prior to eating, simply cut a hole in the top (forming a lid), remove the lid, and add soup/salad/ice cream/etc.

### Example 5

A spherical bread bowl container was manufactured using a Rheon KN400 encrusting machine. Shredded cheese and garlic oil was combined to form a fugitive material. A conceptual product was prepared using the following formulations and equipment. The goal of the experiment is to determine the rheology of the dough in forming a hollow bread loaf for use as a bread bowl. The filling needs to “disappear” leaving a hollow cavity. Rheon KN400 encrusting equipment was used to co-extruded the filling inside of a dough mass. The product shape was that of a sphere and several different sizes. The spherical sizes range from 3 to 6 inches (6 cm to 15 cm) were prepared to evaluate the feasibility of the concept.

### Dough Formula

| Ingredient | Bakers % | Wt.-% |
|---|---|---|
| Flour-Hi gluten | 100.00 | 59.18 |
| Water | 54.00 | 31.95 |
| Salt | 2.00 | 1.18 |
| Sugar | 2.00 | 1.18 |
| Compressed yeast | 5.00 | 2.96 |
| Dough conditioner | 2.00 | 1.18 |
| Shortening Chips | 4.00 | 2.37 |
| Total | 169.00 | 100.00 |

| Fugitive Cheese/Oil filling: | Wt.-% |
|---|---|
| 5 cheese blend | 74.07 |
| Garlic flavored oil | 25.93 |
| Total | 100.00 |

In the machine the operating conditions were:
Dough temperature: 72° F. (22° C.)
Filling temperature: 40° F. (4° C.)
Proofing time: 30 minutes.
Proofing conditions setting: 75% RH at 95° F. (35° C.)
Bake time: 20-30 minutes—depending on size of product.
Bake temp: 375° F. using a convection oven at Rheon.
Mix time: 2 low and 10 high using a single spiral mixer at Rheon Note: the dough was intentionally over mixed for the equipment.

The encrusting co-extrusion machine, KN400, was set at 70:30 dough to filling weight ratio.

Extrusion layer dough weight: approximately 570 grams.

Interior filling weight: approximately 245 grams.

Estimated diameter of the dough ball is 4 inch (10 cm). Diameter after proof and bake is approximately 6 inch (15 cm). The wall thickness was about 1 inch (2.5 cm).

The co-extruded spheres were formed and a small vent hole was pierced into the top center of the ball.

The vent hole is approximately 1/16 in (0.16 cm) diameter.

The product was proofed and baked.

The product was cooled, and then cut to determine the results.

The cooled product displayed an air void in the potential cavity of approximately 15%-20% of the center volume. The void resulted for the combined effect of the increase in the dimension of the exterior bread layer and the decrease in the volume of the fugitive cheese/oil composition. The remainder of the center was cheese filling 80%-85%. The shape of the product retained its boule' or round shape. The remaining cheese was removed and gave the appearance of a substantially spherical hollowed loaf of bread.

Other fillings not remaining in the center void after the baking process can be prepared and extruded from the Rheon encrusting machine to form a roughly spherical unbaked material having an exterior layer comprising the dough and an interior fugitive composition comprising the shredded cheese and oil. The produced unit can be baked at a temperature of about 250° F.-400° F. (120° C.-200° C.) to fully cook the exterior dough layer into a bread product. The dough layer and bread product baked and expanded to form an interior volume between the cheese/oil filling. The final product was about 16 centimeters in diameter and was roughly spherical. A section was cut from the upper portion of the spherical material to a depth of about 2-5 centimeters from the top of the sphere revealing the interior void volume formed by the expansion of the crust and withdrawal of the cheese/oil during cooking. Once opened, the cheese/oil mixture was removed from the bready container leaving an interior volume ideal for addition of a food item. The resulting container had a crisp structural outer crust. The bread portion of the container had a light open cell structure with a crisp outer crust similar to a French baguette. The oily character of the cheese/oil filling provided a hydrophobic moisture barrier to the continuous baked surface of the interior of the structure.

The product of the invention can be manufactured in a food preparation facility using production line techniques to result in a final formed fully baked container. The container can be made with or without the outwardly facing opening preformed at the factory which can be introduced either at a restaurant or during home consumption. Alternatively, the fat free preparation or manufacture can remove a small section from the spherical container at the factory resulting in the upwardly facing opening which can then be distributed to grocery facilities, food stores, restaurants or home consumption. Alternatively, the structure of the invention can be manufactured as a frozen or otherwise preserved food material comprising an unbaked shell having the fugitive material formed within the unbaked dough. Such an item can be distributed in a frozen or otherwise preserved form to restaurants, grocery stores or home use. The structure could then be baked into the final form just prior to consumption.

One important option for use in the invention comprises a moisture barrier at the interior surface of the container structure. Such a moisture barrier would prevent the quick penetration of liquid portion of the food such as a fat, an oil, water or water solution or dispersion from the food into the bready material. The bready material must stay free or substantially free of the introduction of any liquid into the interior of the bread to maintain its mechanical integrity and structure during greater than five minutes, preferably greater than ten minutes in order to provide the consumer sufficient time to consume the contents of the container prior to the container becoming so soft it can no longer support its weight and the weight of the interior contents. Moisture barrier materials that can be useful in such an application include.

Moisture barriers are a means to separate or partition two different components. These barriers can be composed of lipids, carbohydrates, or proteins. Lipid-based barriers are the most effective.

The proposed bread bowls provide a different opportunity for using moisture barriers. Moisture will not be in contact with the bread bowl interior (except for humidity present) until the consumer opens the bread bowl and adds the desired contents. On the other hand, the bread surface in contact with the soup or other food item will be open crumb structure, not protected by a smooth continuous crust.

We incorporate lipids into the material forming the central bread bowl void. When the bread is baked, the solid lipid material will melt and effectively coat the bowl interior. This should effectively restrict moisture migration into the bread bowl crumb, delaying the onset of sogginess. The moisture barrier materials can be introduced into the structure of the invention in a variety of ways. First, the moisture barrier can be extruded as a layer between the fugitive composition and the external dough layer during manufacture. Alternatively, the moisture barrier can be included in either the dough formulation or the interior fugitive composition or both. As the unit is baked, the moisture barrier material can aid in the formation of a layer on the interior surface of the container that is sufficiently moisture resistant to maintain structural integrity. The moisture barrier material included in the fugitive composition, as the fugitive composition began to either gasify and evaporate from the interior of the structure or to melt and soak into or drain from the container of the invention, would leave a residue of the moisture barrier on the internal surface of the container. Certainly not all of the moisture barrier material would remain on the interior surface, but sufficient moisture barrier would form on the surface to act to maintain structural integrity. The formulations of the invention can be manufactured with a range of concentration of the moisture barrier material sufficient to obtain these properties.

The foregoing provides a basis to understand the concept of the invention and various ways to make and use the invention. The invention can take a variety of forms without departing from the spirit and scope of the invention, however, and the invention resides in the claims hereinafter appended.

We claim:

1. A method of making an edible container comprising co-extruding an exterior dough layer and an interior fugitive interior, the exterior layer having a width of greater than 1 centimeters and a length greater than 2 centimeters, the fugitive interior having a diameter of greater than about 0.2 centimeter; the method comprising:
(a) forming the extrudate into a cylindrical portion;
(b) cutting and sealing the portion to form an uncooked manifold comprising the dough as an exterior layer fully enclosing the fugitive composition; and
(c) cooking the uncooked manifold.

2. The method of claim 1 wherein the fugitive composition is dry ice.

3. The method of claim 2 wherein the dry ice is in the form of pellets with a major dimension of less than 0.5 inch.

4. The method of claim 1 wherein the fugitive composition is a semi-fugitive material and is used in an amount greater than about 0.2 gram.

5. The method of claim 1 wherein the fugitive composition is a chemical composition that can generate an inflating gas.

6. The method of claim 5 wherein the inflating gas comprises carbon dioxide, oxygen, nitrogen or mixtures thereof.

7. The method of claim 1 wherein cooking the uncooked manifold comprises parbaking the uncooked manifold.

8. The method of claim 1 wherein cooking the uncooked manifold comprises baking the uncooked manifold.

9. The method of claim 1 wherein the dough layer comprises flour, water, sugar, yeast and shortening.

10. The method of claim 5 wherein the chemical composition comprises single action baking powder or double action baking powder.

11. A method of forming an edible container comprising:
(a) sheeting a dough layer;
(b) cutting the dough into a dough portion;
(c) combining a fugitive composition with each dough portion; and
(d) wrapping the dough portion around the fugitive composition, or placing another dough sheet on top and crimping/cutting, to form an uncooked manifold, an exterior layer of dough with an interior portion of the fugitive composition and cooking the uncooked manifold.

12. The process of claim 11 wherein the fugitive composition is dry ice.

13. The method of claim 12 wherein the dry ice is in the form of pellets with a major dimension of less than 0.25 inch.

14. The method of claim 11 wherein the fugitive composition is used in an amount greater than about 0.2 gram.

15. The method of claim 11 wherein the fugitive composition is a chemical composition that can generate an inflating gas.

16. The method of claim 15 wherein the inflating gas comprises carbon dioxide, oxygen, nitrogen or mixtures thereof.

17. The method of claim 15 wherein the chemical composition comprises single action baking powder, double action baking powder or mixtures thereof.

18. The method of claim 11 wherein cooking the uncooked manifold comprises parbaking the uncooked manifold.

19. The method of claim 11 wherein cooking the uncooked manifold comprises baking the uncooked manifold.

20. The method of claim 11 wherein the dough layer comprises flour, water, sugar, yeast and shortening.

21. The method of claim 1 wherein the chemical composition comprises single action baking powder or double action baking powder.

22. A method of making an edible container comprising:
(a) forming a dough ball;
(b) inserting means to introduce a gas into the dough ball;
(c) inflating the dough ball with a volume of gas to form an inflated uncooked manifold; and
(d) cooking the manifold.

23. The method of claim 22 wherein the dough ball comprises an initial void into which the inflating gas is introduced.

24. The method of claim 22 wherein the dough ball has a radius of about 1 to 10 cm and the inflated manifold has a radius of about 2 to about 25 cm.

25. The method of making an edible container comprising:
(a) forming a dough sheet;
(b) cutting the sheet into pieces;
(c) applying oil or shortening to each piece leaving less than a 1 cm edge;
(d) sealing the unoiled edge to form an uncooked unit; and
(e) baking the uncooked unit at conditions that cause the uncooked unit to inflate into a manifold.

26. The method of claim 25 wherein the inflated manifold is cut forming a container.

27. The method of claim 25 wherein the baked manifold is divided into two edible containers.

28. The method of making an edible container comprising:
(a) forming a dough sheet;
(b) cutting the dough into dough sections;
(c) surrounding an edible shell with a dough section to form an uncooked manifold; and
(d) baking the uncooked manifold.

29. The method of claim 28 wherein the edges of the dough sheet are sealed using a water coating.

30. The method of claim 28 wherein the edges of the dough sheet are crimped to form a tight seal.

31. The method of making an edible container comprising:
(a) co-extruding an external dough layer with an internal filling having a specific gravity less than or equal to about 0.6 gram per milliliter;
(b) having a diameter equal to or greater than about 0.5 cm;
(c) cutting and sealing the extrudate into an uncooked manifold; and
(d) cooking the manifold into a cooked manifold.

32. the method of claim 31 wherein the filling comprises a whipped egg white.

33. the method of claim 31 wherein the filling comprises a whipped food grade polymer.
